(19) United States
(12) Patent Application Publication
(10) Pub. No.: US 2008/0219242 A1
(43) Pub. Date: Sep. 11, 2008

(54) Method for Charging for a Communication Link Routed Via a Packet-Switched Communication Network

(75) Inventors: Wolfgang Deuringer, Munchen (DE); Hermann Granzer, Pocking (DE); Rudolf Stelzl, Dachau (DE); Johann Zeiner, Karlsfeld (DE)

Correspondence Address: BELL, BOYD & LLOYD, LLP, P.O. BOX 1135, CHICAGO, IL, 60690, US

(73) Assignee: Nokia Siemens Networks GmbH & Co. KG, Munchen (DE)

(21) Appl. No.: 11/995,774

(22) PCT Filed: May 29, 2006
(86) PCT No.: PCT/EP2006/062662

§ 371 Date: Mar. 28, 2008

(30) Foreign Application Priority Data
Jul. 15, 2005 (DE) 10 2005 033 236.6

(51) Int. Cl. H04L 12/66

(52) U.S. Cl. 370/352

(57) ABSTRACT

Disclosed is a method for charging for a communication link established from a first communication terminal (A) to a target communication terminal (B) via a packet-switched communication by transmitting message packets, the target communication terminal (B) featuring forwarding to at least one additional communication device (C). The inventive method comprises the following steps: —the first communication terminal (A) sends a signaling message (1) to the target communication terminal (B) via a monitoring network unit (5) of the communication network (4); —the target communication terminal (B) sends a reply signaling message (2), in which forwarding is indicated, into the communication network (4) after receiving the signaling message (1); —a fee calculation system that is installed at least in part in the monitoring network unit (5) uses the reply signaling message (2) for allocating charges, the forwarding charges being allocated to the first communication device (A) or the target communication device (B).

### CLAIM FOR PRIORITY

This application is a national stage application of PCT/EP2006/062662, filed May 29, 2006, which claims the benefit of priority to German Application No. 10 2005 033 236.6, filed Jul. 15, 2005, the contents of which hereby incorporated by reference.

### TECHNICAL FIELD OF THE INVENTION

The invention relates to a method for charging for a communication link which is set up from a first communication terminal to a destination communication terminal via a packet-switched communication network, the destination communication terminal having set up forwarding to at least one further communication device.

### BACKGROUND OF THE INVENTION

For some years, it has been possible to see a clear trend in telecommunication, leading away from conventional telephony toward universal data-network-based communication services. A fundamental driving force for this development is the opportunity to be able to provide added-value services beyond conventional, purely voice-based telephony. Examples which may be mentioned in this regard are video telephony, which is possible only inadequately in the conventional telephone network on account of a lack of data bandwidth, what are known as presence and availability services, which make it possible to indicate whether and how a called subscriber can be reached, and also other communication services, such as newsletters. The provision of these added-value services is becoming increasingly popular on the Internet. Providers of conventional telecommunication services are therefore anxious to provide their customers with these added-value services in their systems too. The introduction of these services has been unsuccessful to date not so much on account of the technical circumstances of the infrastructure but rather primarily on account of the demands on the charging. Connection- or line-dependent charging is no longer or only restrictedly possible in data networks, such as the Internet, since the data lines are used jointly by a large number of users and explicit association is therefore no longer possible. Normally, this involves charging on the basis of data transfer volume instead of time/zone-dependent charging.

However, known charging mechanisms are already found to be inadequate when it is necessary to account correctly for the charges incurred for transmitting voice information between a calling subscriber and a called subscriber who has set up call redirection. For a diverted call for which it is known that the called subscriber would need to be charged at least in part in the event of a call diversion, existing approaches to a solution involve the calling subscriber being called upon even though the redirection was generally not his intention. This problem situation arises not only for call diversion but also for announcements and added-value services, for example, on a general basis. It is exacerbated particularly when an added-value service is retrieved from a packet-based communication network, for example using the known “added-value telephone numbers” in the form 0190xxx or 0900xxxo. A packet-based communication network does not have explicit line and subscriber identification association, such as provided by the telephone number in a conventional telecommunication network. It may therefore arise that the communication subscriber is encumbered by charges with abusive intent as a result of the aforementioned inadequate charging mechanisms.

### SUMMARY OF THE INVENTION

The present invention is discloses a method for charging for a communication link which is set up from a calling communication terminal to at least one destination communication terminal via a packet-switched communication network such that the first communication appliance is not encumbered by charges which are caused by forwarding which has been set up by a called destination communication terminal.

As a result of a central idea of the invention, a response signaling message in which the forwarding is indicated is returned to the packet-switched communication network by a called destination communication terminal, having received a signaling message from the calling communication terminal, and is used by a billing system for correct charge allocation.

In one embodiment, the forwarding is marked in the response signaling message through the incorporation of an additional information field. This allows controlling units in the network, for example SIP proxy or H.323 gatekeeper, to register this forwarding and therefore mark it such that the initiator of the message, that is to say the forwarding destination communication terminal, is entered in the signaling message as needing to be charged. A billing system evaluates this additional information and ensures correct charging.

In another embodiment of the invention, the response signaling message is routed back to the first communication terminal, the path not necessarily needing to be routed via a controlling network unit. That is, the called communication terminal is thus set up for direct sending. Following receipt of the response signaling message, the forwarding is indicated in the calling first communication terminal by an indicator device. Forwarding to the at least one further communication device takes place if the calling communication terminal is used to input a piece of confirmation information which a calling subscriber uses to indicate to the billing system that he agrees to accept the charges for forwarding.

In still another embodiment of the invention, a destination communication terminal more or less “regularly” directs its call redirection (forwarding) to the controlling unit (for example SIP proxy) and this unit then ensures correct charging. Advantageously, the calling first communication terminal does not need to be informed about this redirection, since no additional charges are incurred for this (calling) subscriber. In this embodiment of the invention, the calling first communication terminal device is therefore not aware of the diversion. Possible abuse of the charging is prevented by the combination with the second embodiment of the invention in that, in the case of forwarding which cannot be marked by the controlling unit, explicit active (for example by pressing a key or the like) or passive (e.g. predefined list) confirmation is requested.

For the execution of the method, it is preferable if the first communication terminal is a multimedia terminal which has a graphical user interface. This allows the forwarding to be indicated and allows a user to react to it accordingly.

It is a simple matter for the indicator device to be formed by a pop-up window in the graphical user interface. This means that the confirmation information can easily be input by the calling subscriber using a dialog box.

It may also be advantageous if the first communication terminal device is formed by an IP telephone. This makes it a simple matter for the confirmation information to be input by pressing a confirmation key on this IP telephone.

In respect of user friendliness, it may be beneficial if the confirmation is requested by inputting a piece of voice information.

It is advantageous if the information field is incorporated into the message header of a message packet.

It may also be advantageous if the identity of a called subscriber associated with a destination communication terminal is indicated on the graphical user interface of the first, calling communication terminal device.

The controlling network unit is advantageously formed by an SIP proxy or by an H.323 gatekeeper.

### BRIEF DESCRIPTION OF THE DRAWINGS

The invention is explained in more detail below by way of example with reference to the appended figures, in which:

FIG. 1 shows a schematic illustration of a scenario for the ascertainment of charges in a packet-based communication network based on the prior art.

FIG. 2 shows a first embodiment of the inventive method.

FIG. 3 shows a second embodiment of the inventive method.

### DETAILED DESCRIPTION OF THE INVENTION

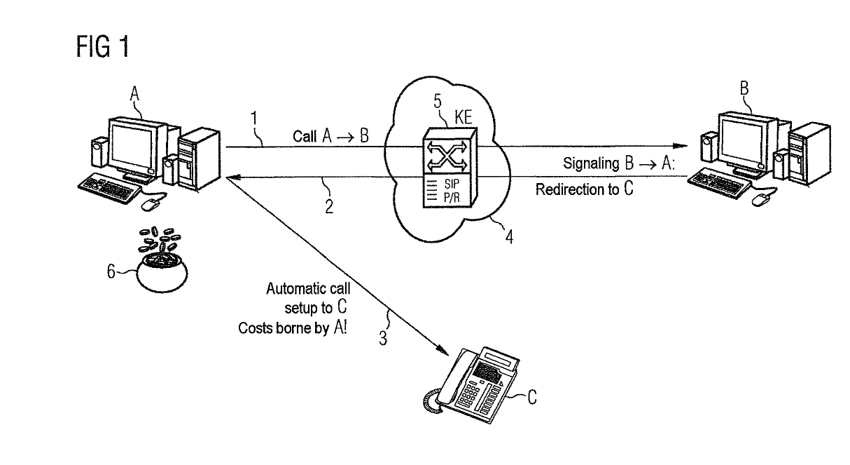

FIG. 1 shows a communication terminal device A associated with a first communication subscriber who sets up a connection to a communication terminal device B associated with a second communication subscriber by means of a call (“call A->B”). In this case, the second communication subscriber has set up call redirection to a terminal C (in FIG. 1 the telephone associated with a third communication subscriber). Each communication device A, B, C has a respective associated subscriber whose terms for paying charges are known to a billing system. The terminal devices A and B are shown as multimedia terminals. The transmission channel between A and B is routed via a communication network 4 which contains a packet-based communication network or is formed by the latter. In the communication network 4, messages are thus transmitted at least progressively in the form of message packets. The signaling for setting up the connection between the terminal A and the terminal B is identified in FIG. 1 by an arrow with the reference symbol 1. In the communication network 4, a control unit KE, identified by the reference symbol 5, forwards the information “call A->B”. As a result of the call redirection set up by the called subscriber B, the terminal B transmits a response signaling message directed to the terminal A associated with the calling subscriber, that is to say in the example a diversion signaling message (“signaling B->A: redirection to C”). This response signaling message indicates the terminal C as the new terminal point. The transmission of this response signaling message to the terminal A is likewise handled by the control unit 5 (arrow with reference symbol 2 in FIG. 1). This results in automatic call setup to terminal C. Although the calling subscriber would merely need to be charged for the connection between the appliances A and B, the prior art involves him also being inflicted with the charges for forwarding, that is for the continued transmission link to the terminal C associated with the third communication subscriber. In FIG. 1, this previously effected incorrect charging is indicated by a graphic identified by the reference symbol 6.

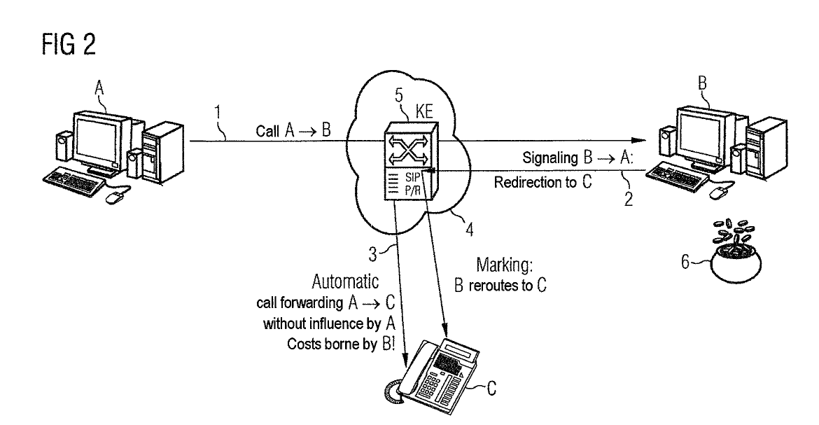

FIG. 2 shows a first embodiment of the inventive method. The call from a subscriber A (“call A->B”) is transmitted to the subscriber B via a control unit 5 in a packet-based data network 4 (arrow with reference symbol 1). In the example shown, the control unit 5 is a specially set-up SIP proxy server. Alternatively, the control unit 5 may be provided by an H.323 gatekeeper or else may be an MGCP-based terminal with a currently available or prospective protocol. In this case too, the call A->B from the communication terminal B associated with the called subscriber prompts the transmission of a diversion signaling message (“signaling B->A: redirection to C”) back to the data network 4 (arrow with reference symbol 2 in FIG. 2). This response signaling message includes a piece of information about the redirection initiated by the subscriber B. In the example in FIG. 2, the redirection is again made to a telephone which is identified by the reference symbol C. It goes without saying that the redirection may alternatively be made to a plurality of communication appliances, even in different forms, such as to a mobile telephone and/or a multimedia terminal. The control unit 5 receives this signaling message and incorporates a marker in a field in the signaling message in order to ensure correct charging. There is subsequently “automatic call forwarding A->C” in this case too (arrow with reference symbol 3 in FIG. 2). This call forwarding takes place without any influence by the calling subscriber's terminal A. However, the inventive marker means that it is now possible for a charging system (not shown in more detail in FIG. 2) which evaluates this marker in a manner which is known per se, to invoice charges incurred for the connection between the terminal devices B and C not to the calling subscriber A but rather correctly to the subscriber B who prompted the redirection. In the FIG. 2, this accounting for subscriber B is indicated by a graphic with the reference symbol 6.

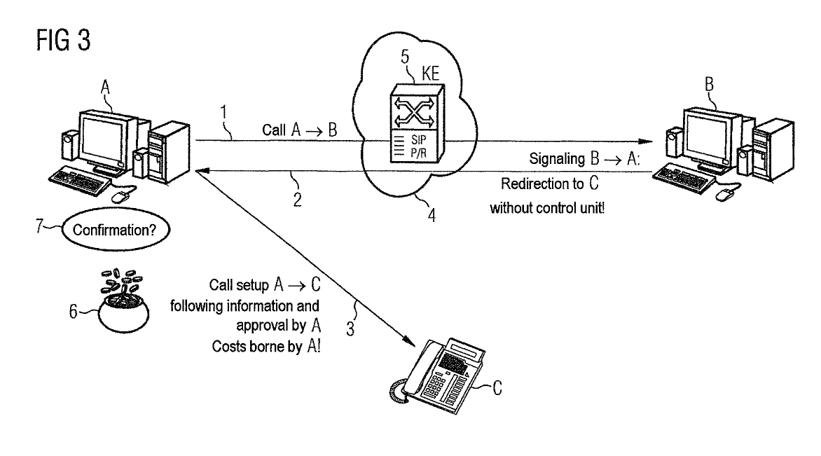

FIG. 3 shows a second embodiment of the inventive method. In this case, too, the connection is initiated by a call routed via a control unit 5 and the network 4 (“call A->B” in FIG. 3). In this exemplary embodiment, too, the control unit 5 is shown as an SIP proxy server, which can naturally be provided by an H.323 gatekeeper or a similar server with an appropriate different protocol in this case too. In the called subscriber's terminal B, call diversion is engaged. The called subscriber's terminal B sends a diversion signaling message (“signaling B->A: redirection to C”) to the data network 4. This diversion signaling message is transmitted to the calling subscriber's subscriber terminal device A via the data network 4—without the involvement of the control unit 5. In contrast to the first embodiment of the invention explained above, however, there is no automatic call forwarding in this case. In line with the basic idea of the present second embodiment of the invention, the transmission link is continued, that is the call setup from terminal A to terminal C (“call setup A->C”; arrow with the reference symbol 3 in FIG. 3), following information and approval from the calling subscriber. For this, the functionality of the multimedia terminal A or B is extended accordingly. The multimedia terminal B is set up such that it can transmit redirection signaling by the data network 4 to the calling subscriber's multimedia terminal A without insertion of the control unit 5. The multimedia terminal A is equipped with an indicator which allows the calling subscriber to see that his call originally directed to the subscriber B has been redirected. If the calling subscriber agrees to the call redirection and the charging which may be incurred for him as a result, he signals this by making a particular input on his terminal A, for example. Only if he accepts the diversion and the resultant billing is a call set up to the third communication terminal C. It goes without saying that in this case too it is possible for the call to be redirected to a plurality of communication terminals, which are of technically different design, instead of the one terminal C.

As already illustrated above, a particularly advantageous refinement of the invention is obtained by combining the method steps explained in FIG. 2 and FIG. 3.

The “confirmation” 7 which the calling subscriber inputs on his communication terminal device A in line with the schematic illustration in FIG. 3 as a symbol of his agreement to the call redirection may be provided in different ways depending on the implementation of the terminal device A (for example by a button in the case of a multimedia terminal, a dialog box on a software terminal or by another kind of manifestation of will, for example by voice control).

It is also possible for the indication of the call redirection to be implemented on the appliance A in different ways, for example by a pop-up window on a graphical interface or on a PC-based software telephone. In the case of a hardware-based Internet telephone, the call redirection can be effected audibly or can be implemented by an appropriate indicator on a display.

It is also conceivable for the calling subscriber to define what is known as a black list or a white list. These lists indicate whether redirection requests from particular communication subscribers are to be accepted always (white list) or never (black list). In this case, the diverted messages do not need to be marked by the control unit, since the call is redirected by the calling subscriber himself.

1. A method of charging for a communication link, comprising:
setting up the communication link from a first communication terminal to a destination communication terminal via a packet-switched communication network by transmitting message packets, the destination communication terminal having set up forwarding to at least one further communication device;
sending a signaling message from the first communication terminal using a controlling network unit in the communication network to the destination communication terminal;
sending from the destination communication terminal, having received the signaling message, a response signaling message to the communication network which indicates the forwarding;
setting up a billing system, which is at least partly located in the controlling network unit, which uses the response signaling message for charge allocation; and
allocating the charges incurred for forwarding either to the first communication appliance or to the destination communication appliance.

2. The method as claimed in claim 1, wherein the response signaling message returned to the communication network by the destination communication terminal is received by the controlling network unit and is marked by the destination communication terminal, by incorporating an additional information field of a message packet, such that the billing system recognizes from the information field that charges for the forwarding are being borne by the destination communication terminal.

3. The method as claimed in claim 1, wherein the response signaling message is routed back to the first communication terminal via network nodes in the communication network, without including the controlling network unit, and is indicated on the communication terminal by an indicator device, and the forwarding to the at least one further communication device takes place if a piece of confirmation information which is input on the first communication terminal indicates to the billing system that the charges for forwarding are being borne by the first communication terminal.

4. The method as claimed in claims 2, wherein unmarked data packets are forwarded to the at least one further communication appliance if a piece of confirmation information is input by the first communication terminal.

5. The method as claimed in claim 3, wherein the first communication appliance is a multimedia terminal which has a
graphical user interface, and the indicator means are formed by this user interface.

6. The method as claimed in claim 5, wherein the indicator device is formed by a pop-up window on the graphical user interface, and the confirmation information is input using a dialog box.

7. The method as claimed in claim 4, wherein the first communication terminal device is an IP telephone, and the indicator device is formed by a display indicator and confirmation information is input using a confirmation key.

8. The method as claimed in claim 4, wherein the first communication terminal device is set up for voice input, and the confirmation information is input by voice.

9. The method as claimed in claim 2, wherein the information field is incorporated into a message header of a message packet.

10. The method as claimed in claim 5, wherein the identity of a called subscriber associated with the at least one destination communication terminal is indicated on the graphical user interface.

11. The method as claimed in one, claim 1, wherein the controlling network unit is formed by an SIP proxy or by an H.323 gatekeeper.

12. The method as claimed in, claim 1, wherein the first communication terminal is connected to the packet-switched communication network via an Internet access network.

13. The method as claimed in, claim 1, wherein the controlling network unit performs continuous charge ascertainment for the communication link which has been set up.

14. The method as claimed in claim 3, wherein the first communication terminal includes a piece of black/white list information associated with a group of destination communication terminals, which information is used for setting up forwarding.
